(19) United States
(12) Patent Application Publication
(10) Pub. No.: US 2004/0051885 A1
(43) Pub. Date: Mar. 18, 2004

(54) Image processing apparatus, image processing method, and image processing program product

(75) Inventor: Junichi Matsunoshita, Kangawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/384,653

(22) Filed: Mar. 11, 2003

(30) Foreign Application Priority Data
Sep. 18, 2002 (JP) 2002-272351

(51) Int. Cl. G06F 15/00; G06F 3/12; H04N 1/407; B42D 15/00

(52) U.S. Cl. 358/1.9; 283/902; 358/3.28

(57) ABSTRACT

An image processing apparatus that generates a background pattern to be combined with document data includes a pattern generator. This pattern generator generates a background pattern that includes a first region in which patterns that correspond to a predetermined code and are to be reproduced at a time of duplication are arranged, a second region in which patterns that are not to be reproduced at a time of duplication are arranged, and camouflage patterns formed by variations of the patterns to be reproduced at a time of duplication and the patterns not to be reproduced at a time of duplication.

### BACKGROUND OF THE INVENTION

1. Field of the Invention

The present invention generally relates to an image processing device, an image processing method, and an image processing program product, and more particularly, to a technique of generating background patterns corresponding to document data from which making unauthorized duplicates to produce forged documents is prohibited, and combining the generated background patterns with the document data.

2. Description of the Related Art

In recent years, there have been many reported cases of secret information leakage through unauthorized duplication of classified documents conducted with personal computers, printers, and copying machines that are now widely available. As the number of troubles involving unauthorized duplication has increased, many solutions have been suggested.

As the prior art of restricting unauthorized duplication of classified documents and leakage of secret information, Japanese Unexamined Patent Publication No. 2000-197297 discloses the technique of performing image processing to generate a background pattern that can achieve the same effects as a copy guard sheet (the background pattern will be hereinafter referred to as the “copy guard pattern”). According to this technique, the copy guard pattern is combined with each document image, and the combined image is printed out. This copy guard pattern is a patterned image in which a character string such as “DUPLICATION PROHIBITED” is embedded in the background with uniform density.

A latent image area is formed by patterns different from the patterns forming the background area. However, those patterns are formed so that the average dot density in the latent image area is the same as the average dot density in the background area. Thus, the latent characters are difficult to recognize visually. In the latent character area, patterns formed by relatively large dots that are to be reproduced by a copying machine are relatively sparsely arranged. In the background area, patterns formed by relatively small dots that are not to be reproduced by a copying machine are relatively densely arranged.

In a case where this pattern image is combined with the entire background of a document image and the combined image is printed out, the entire background has uniform color shade and uniform density, and the latent characters do not visually stand out. However, when the printed image is duplicated by a copying machine, the dot patterns in the latent character area are reproduced, but the dot patterns in the background area are not reproduced. As a result, the background area turns out to be blank, and the characters “DUPLICATION PROHIBITED” appear in the background area of the document image printed out. This serves as a psychological stopper against unauthorized duplication, as well as a distinction between the original copy and the duplicate copy.

The background pattern of the copy guard pattern may be formed by two-dimensional codes. A camouflage pattern formed separately from a latent pattern may be combined with a copy guard pattern, with the colors of the camouflage pattern and the copy guard pattern being the same or different from each other. Alternatively, a camouflage pattern may be formed by an outlined shape against a colored background in a part of a copy guard pattern, so that the latent image cannot be easily seen. Here, a “camouflage pattern” is a pattern to be added to a copy guard pattern, so that the character string contained in the copy guard pattern becomes more invisible.

When the camouflage pattern is simply applied to the copy guard pattern formed by the two-dimensional codes, the precision of detecting the two-dimensional codes and the quality of the latent image may be degraded.

### SUMMARY OF THE INVENTION

The present invention has been made in view of the above circumstances and provides an image processing apparatus, an image processing method, and an image processing program product in which the above disadvantages are eliminated.

More specifically, the present invention provides an image processing apparatus, an image processing method, and an image processing program product that can form a camouflage pattern with neither a decrease of precision in detecting a predetermined code formed with patterns reproducible at a time of duplication, nor a deterioration of image quality in a latent image.

### BRIEF DESCRIPTION OF THE DRAWINGS

Preferred embodiments of the present invention will be described in detail based on the accompanying drawings, wherein:

FIG. 1 illustrates an image processing system in accordance with a first embodiment of the present invention;

FIG. 2 illustrates the inner structure of the multi-function apparatus of the image processing system of FIG. 1;

FIG. 3 is a block diagram of the copy guard pattern generator of the multi-function apparatus of FIG. 2;

FIGS. 4A through 4C illustrate an example of a copy guard pattern image;

FIGS. 5A through 5F illustrate patterns stored in the pattern storage unit of the copy guard pattern generator of FIG. 3;

FIG. 6 illustrates an example of a camouflage pattern stored in the camouflage pattern storage unit shown in FIG. 3;

FIG. 7 shows a pattern selection logic table used by the pattern selector shown in FIG. 3;

FIG. 8 illustrates a two-dimensional code of 15×15 bits;

FIG. 9 is a flowchart of an image forming operation by a printer driver in accordance with a third embodiment of the present invention; and

FIGS. 10A through 10C illustrate a conventional background pattern image.

### DESCRIPTION OF THE PREFERRED EMBODIMENTS

A description will first be given of related art of the present invention.

The applicant notes a technology of forming the background patterns of a copy guard pattern with two-dimensional codes for restricting unauthorized duplication of classified documents and leakage of secret information. By this technique, the psychological stopper effect against unauthorized duplication can be obtained, as the latent characters embedded in the copy guard pattern turn visible. Also, by this technique, the name of the user who has printed out the document, the date of the printout, and the IP (Internet Protocol) address of the client apparatus that has transmitted the print job, are hidden in the two-dimensional codes forming the background area of the copy guard pattern. With those kinds of information being contained in the copy guard pattern, it is possible to find out where each unauthorized duplicate copy of the classified document is originated from, and a greater stopper effect against information leakage can be achieved.

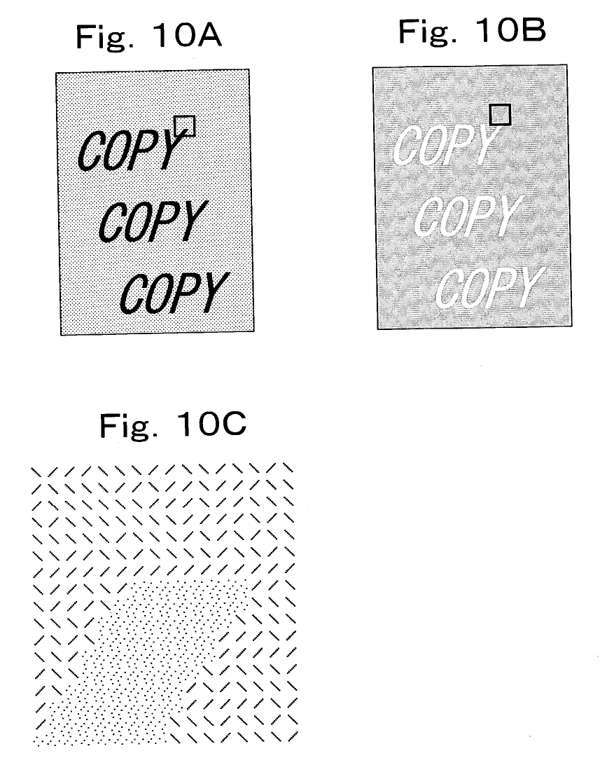

It is also possible to combine the above technique with a copying machine having a function of detecting two-dimensional codes. Duplication prohibiting information is embedded beforehand in the two-dimensional codes in the copy guard pattern in the background of a classified document, so that duplication of the classified document can be entirely prohibited. This conventional copy guard pattern image will be described below, with reference to FIGS. 10A through 10C. Fig. 10A illustrates the entire image of a copy guard pattern.

The image data are of a binary monochrome image with a bit density of 1 bit per pixel. In this drawing, the characters “COPY” are latent characters. The latent characters are not to be seen in practice as clearly as shown in Fig. 10A in which the latent characters can be clearly seen for ease of explanation. FIG. 10C is an enlarged view of a part of the latent characters. Inside each of the latent characters, relatively small dots are randomly and densely arranged. Outside the latent characters, two types of relatively large diagonal patterns are relatively sparsely arranged.

The patterns arranged in the background area are very thin linear patterns, as can be seen from FIG. 10C. These patterns can be reproduced when the document image is duplicated by a copying machine. On the other hand, the dot patterns of the latent characters are randomly arranged dots, as shown in FIG. 10C. These patterns cannot be adequately reproduced when the document image is duplicated by a copying machine.

Although the patterns are different between the inside and the outside of the latent characters, the average density (the ratio of the black pixel area to a unit area) inside the latent characters is equal to the average density outside the latent characters on a paper sheet on which the document image is printed out. Accordingly, the entire background looks grayish to the human eye. When the document having this image printed out thereon is duplicated by a copying machine, the relatively large diagonal patterns outside the latent characters are accurately reproduced, but the relatively small dots inside the latent characters are not adequately reproduced. As a result, only the outside (the background area) of the latent characters is reproduced on the duplicate copy, but the latent character areas appear as blank areas on the duplicate copy. This image is shown in FIG. 10B.

An image to be actually printed out onto a paper sheet is a composite image formed by combining a document image with the pattern image shown in FIG. 10A. In this example, however, a case of printing out a completely blank document image not including characters and drawings is taken as an example, for ease of explanation. Also, the background area of the copy guard pattern serves as a two-dimensional code area formed by two types of diagonal patterns each representing a bit “0” or “1”, so that digital information can be embedded in the copy guard pattern.

In a case of producing a conventional copy guard sheet, a camouflage pattern formed separately from a latent pattern is combined with a copy guard pattern, with the colors of the camouflage pattern and the copy guard pattern being the same or different from each other. Alternatively, a camouflage pattern may be formed by an outlined shape against a colored background in a part of a copy guard pattern, so that the latent image cannot be easily seen. Here, a “camouflage pattern” is a pattern to be added to a copy guard pattern, so that the character string contained in the copy guard pattern becomes more invisible.

In either case of producing the above conventional camouflage patterns, however, the technique of forming the background area of a copy guard pattern with two-dimensional codes is not taken into consideration. Accordingly, simple application of either of the conventional camouflage patterns to the above copy guard pattern with two-dimensional codes might reduce the precision in detecting the two-dimensional codes. For instance, in a case where a copy guard pattern is combined with a camouflage pattern of the same color as the color of the copy guard pattern or a color different from the color of the copy guard pattern, the camouflage pattern overlaps the diagonal patterns forming the two-dimensional codes, and thereby hinders the detection of the two-dimensional codes. Also, in a case where a camouflage pattern is formed by an outlined shape against a colored background in a part of a copy guard pattern, the diagonal patterns are partially erased. As a result, the detection of the two-dimensional codes becomes more difficult.

According to an aspect of the present invention, a camouflage pattern can be formed with neither a decrease of precision in detecting a predetermined code formed with patterns reproducible at a time of duplication, nor a deterioration of image quality in a latent image.

(First Embodiment)

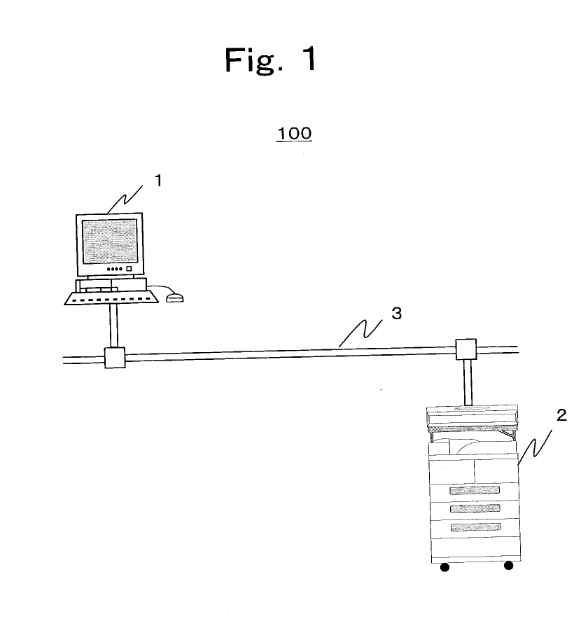

FIG. 1 illustrates an image processing system in accordance with a first embodiment of the present invention. As shown in FIG. 1, in an image processing system 100, a client apparatus 1 that is a personal computer and a full-color multi-function apparatus 2 that has a printing function and a copying function are connected to a network 3 such as the Internet. The multi-function apparatus 2 corresponds to the image processing apparatus of the present invention. In a second embodiment of the present invention that will be described later, the client apparatus 1 corresponds to the image processing apparatus of the present invention.

When document data are to be printed out in accordance an instruction from the client apparatus 1 in the image processing system 100, the printer driver installed in the client apparatus 1 converts the document data into PDL data that are written in a PDL (Printer Description Language). The PDL data are then transmitted to the multi-function apparatus 2 via the network 3. Based on the PDL data, the multi-function apparatus 2 determines whether the document data are derived from a classified document. If the document data are derived from a classified document, the multi-function apparatus 2 processes the PDL data in a predetermined manner that will be described later, and converts the PDL data into raster image data. The multi-function apparatus 2 then prints out the raster image data.

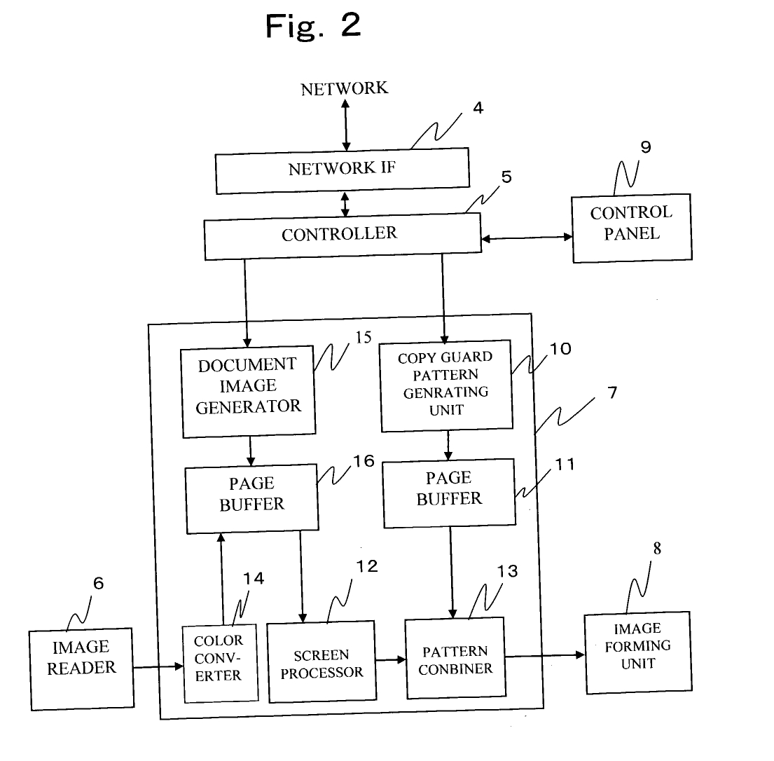

The inner structure of the multi-function apparatus 2 shown in FIG. 1 will now be described. FIG. 2 illustrates the inner structure of the multi-function apparatus 2. As can be seen from FIG. 2, the multi-function apparatus 2 includes a network interface 4, a controller 5 that controls the entire multi-function apparatus 2, an image reader 6 that reads originals as read images, an image processing unit 7 that performs a predetermined process on input images, an image forming unit 8 that forms full-color images on paper sheets, and a control panel 9 that displays information for users and manages key input operations.

The network interface 4 receives PDL data from the client apparatus 1 via the network 3, and performs communication with other network connection devices. The header of the PDL data contains additional information including the IP address of the computer that has transmitted the print job, the name of the user who has transmitted the print job, the file name of the document to be printed, and the time stamp of the document to be printed out. The header of the PDL data further contains copy guard pattern setting information.

The copy guard pattern setting information includes predetermined information such as a character string to be embedded as latent characters and the number allotted to a camouflage pattern to be combined with the copy guard pattern. The copy guard pattern setting information is added only to classified documents that need to be protected from unauthorized duplication. If a copy guard pattern is detected from a document, the document is determined to be a classified document.

The controller 5 includes a memory (not shown) that stores the PDL data received at the network interface 4, and determines whether the additional information and the copy guard pattern setting information are contained in the PDL data stored in the memory. If the copy guard pattern setting information is contained in the PDL data, the controller 5 sets the operation mode of the multi-function apparatus 2 to a copy guard pattern combining mode. The controller 5 also retrieves the latent character string information, the color information, and the camouflage pattern number from the additional information and the copy guard pattern setting information, and then performs setting on a copy guard pattern (background pattern) generator 10 (described later) that is located in the image processing unit 7.

If the copy guard pattern setting information is not contained in the PDL data, the controller 5 sets the operation mode of the multi-function apparatus 2 to a regular operation mode. In this regular operation mode, the copy guard pattern generating process and the combining process that will be described later in detail are not carried out.

The image processing unit 7 includes a document image generator 15, a page buffer 16, the copy guard pattern generator 10, a page buffer 11, a screen processor 12, a pattern combiner 13, and a color converter 14. The document image generator 15 analyzes the PDL data to generate a document image. The document image to be generated from the document image generator 15 is formed from full-color image data made up of four color components of black, cyan, magenta, and yellow, corresponding to the printer resolution. The page buffer 16 temporarily stores the document image data generated from the document image generator 15.

The copy guard pattern generator 10 generates images such as a copy guard pattern image (a background pattern) including: a first region (a background area) that corresponds to a predetermined code (a two-dimensional arrangement code, for example) and in which patterns to be reproduced at a time of duplication are arranged; a second region (a latent image area) in which patterns not to be reproduced at a time of duplication are arranged; and camouflage patterns formed by modified versions of the patterns to be reproduced at a time of duplication and the patterns not to be reproduced at a time of duplication. The copy guard pattern image is formed from binary image data corresponding to the printer resolution. The copy guard pattern generator 10 generates the copy guard pattern image, based on the latent character string, the camouflage pattern number, and the additional information supplied from the controller 5. Here, the additional information contains the IP address of the client apparatus 1 and the name of the user who has logged in.

The page buffer 11 temporarily stores the document image data generated from the copy guard pattern generator 10. The screen processor 12 sequentially reads the full-color image data of CMYW (Cyan, Magenta, Yellow, and Black) from the page buffer 16, and performs screen processing on the full-color image. The pattern combiner 13 combines the image data processed by the screen processor 12 with the copy guard pattern image data stored in the page buffer 11.

A pattern image (an unauthorized duplication prohibiting image) in which a copy guard pattern for prohibiting forgery through unauthorized duplication is embedded is combined with the document image data of each classified document. On the other hand, the copy guard pattern setting information is not added to the document image data of any document other than classified documents, and accordingly, a copy guard pattern is not combined with the document image data of any document other than classified documents. The color converter 14 converts the color space of full-color image input from the image reader 6 into a CMYK color space.

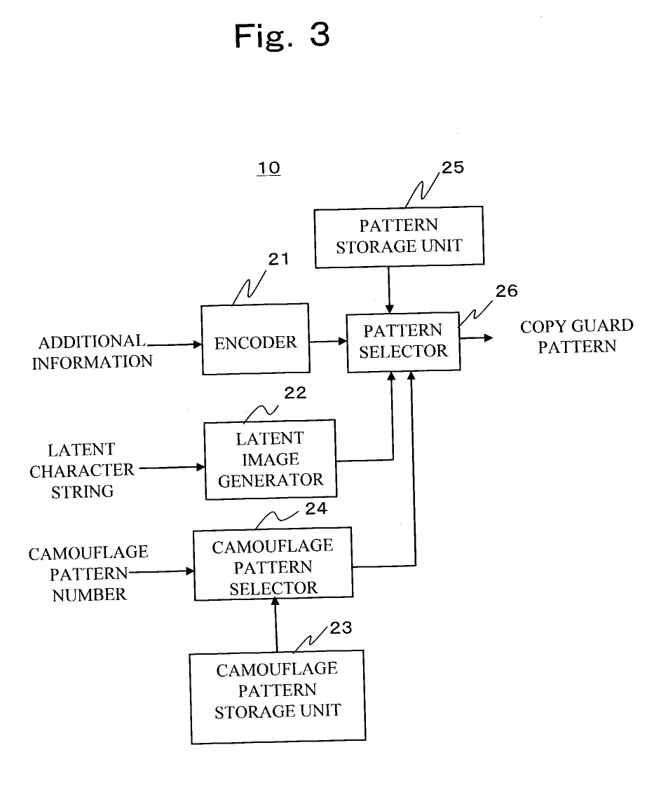

Referring now to FIG. 3, the copy guard pattern generator 10 will be described in detail. As can be seen from FIG. 3, the copy guard pattern generator 10 includes an encoder 21, a latent image generator 22, a camouflage pattern storage unit 23, a camouflage pattern selector 24, a pattern storage unit 25, and a pattern selector 26. The copy guard pattern generator 10 receives latent character strings, camouflage pattern numbers, and additional information from the controller 5.

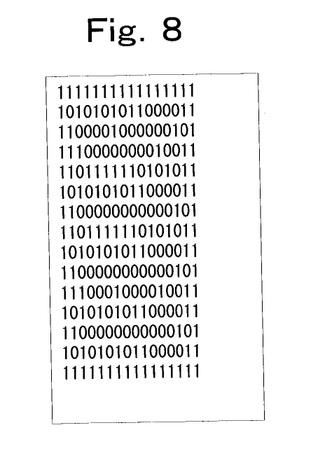

The encoder 21 performs error correction encoding on the additional information input from the controller 5, and thereby generates a two-dimensional arrangement code. The additional information subjected to the error correction encoding is represented by a bit string consisting of “0” and “1”. These bits contained in the bit string are read out one by one, and are then rearranged in a two-dimensional arrangement of a predetermined length (a unit two-dimensional arrangement). A bit string is shown in FIG. 8. FIG. 8 shows a two-dimensional code of 15×15 bits.

The bits on the outermost periphery of this unit two-dimensional arrangement are all “1”, so that the positioning and separating of the code data can be readily performed. This unit two-dimensional arrangement repeatedly appears in the vertical and horizontal directions, so as to form a two-dimensional arrangement of a size corresponding to the number of pixels contained in the latent character image. The code data (the two-dimensional arrangement codes) that have been subjected to the error correction encoding, rearranged in the two-dimensional arrangements, and subjected to code conversion in accordance with the latent character image data, are output to the pattern selector 26. Accordingly, the additional information that has been subjected to the error correction encoding is represented by bit strings of “0” and “1”. The two-dimensional codes that appear on the entire image area of 50 dpi (dots per inch) in resolution are then output to the pattern selector 26.

The latent image generator 22 subjects each latent image string input from the controller 5 to raster development, so as to generate binary latent character image data. Each latent image generated from the latent image generator 22 is formed with a resolution of one twelfth of the printer resolution. For instance, if the printer resolution is 600 dpi, the latent image is formed with a resolution of 50 dpi.

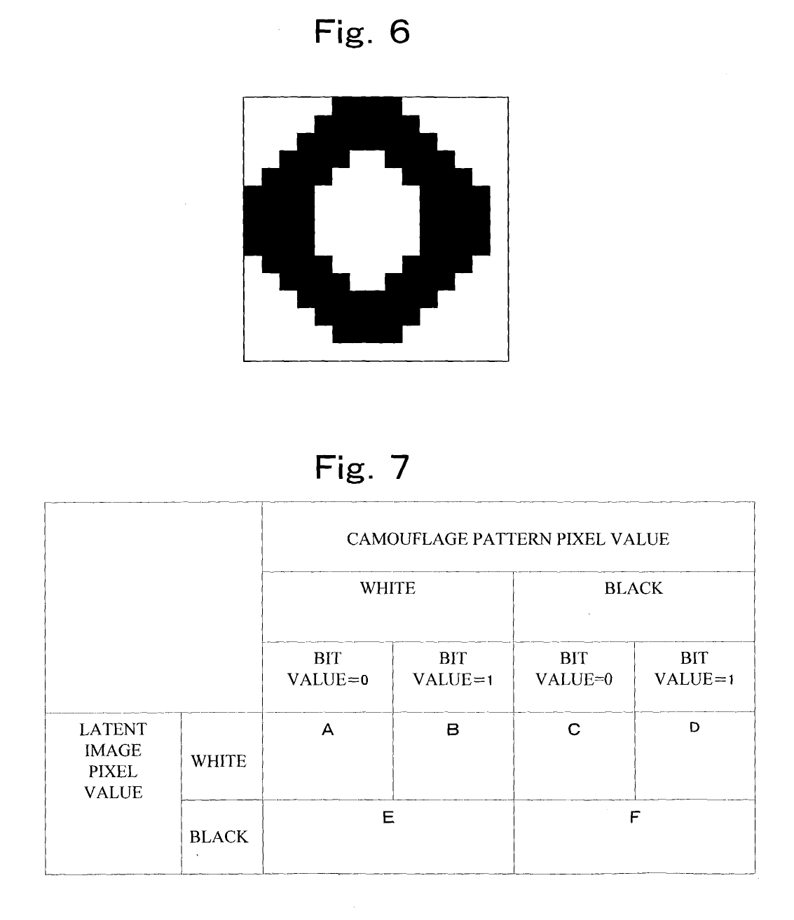

The camouflage storage unit 23 stores camouflage patterns. FIG. 6 illustrates an example of a camouflage pattern stored in the camouflage pattern storage unit 23. This camouflage pattern is formed from binary image data of 15×15 pixels.

The camouflage pattern selector 24 selects a camouflage pattern corresponding to the camouflage pattern number (information) input from the controller 5, from the camouflage patterns stored in the camouflage pattern storage unit 23. The camouflage pattern selector 24 then repeatedly places the selected camouflage pattern on the entire image area of 50 dpi in resolution, and outputs the repetitive selected camouflage patterns to the pattern selector 26.

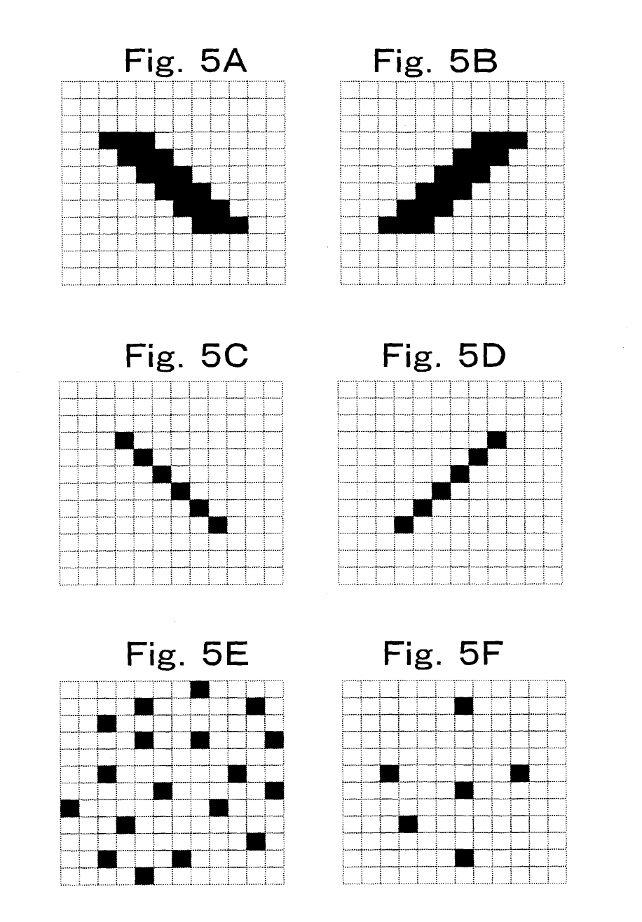

For instance, the pattern storage unit 25 stores six types of patterns: a bold diagonal pattern that is tilted to the left as shown in FIG. 5A, a bold diagonal pattern that is tilted to the right as shown in FIG. 5B, a diagonal pattern that is tilted to the left as shown in FIG. 5C, a diagonal pattern that is tilted to the right as shown in FIG. 5D, a dot pattern that has a higher dot density in the predetermined pattern cell as shown in FIG. 5E, and a dot pattern that has a lower dot density in the predetermined pattern cell as shown in FIG. 5F. The patterns shown in FIGS. 5A through 5D can be accurately reproduced through duplication by the multi-function apparatus 2. On the other hand, the patterns shown in FIGS. 5E and 5F are not adequately reproduced through duplication by the multi-function apparatus 2.

The pattern selector 26 selects one of the six patterns stored in the pattern storage unit 25, based on the value of each bit in the code input from the encoder 21, the pixel value of each pixel in the camouflage pattern image input from the camouflage pattern selector 24, and the pixel value of each pixel in the latent image input from the latent image generator 22. The pattern selector 26 then outputs the selected pattern as image data. The logic in the pattern selection by the pattern selector 26 is shown in FIG. 7.

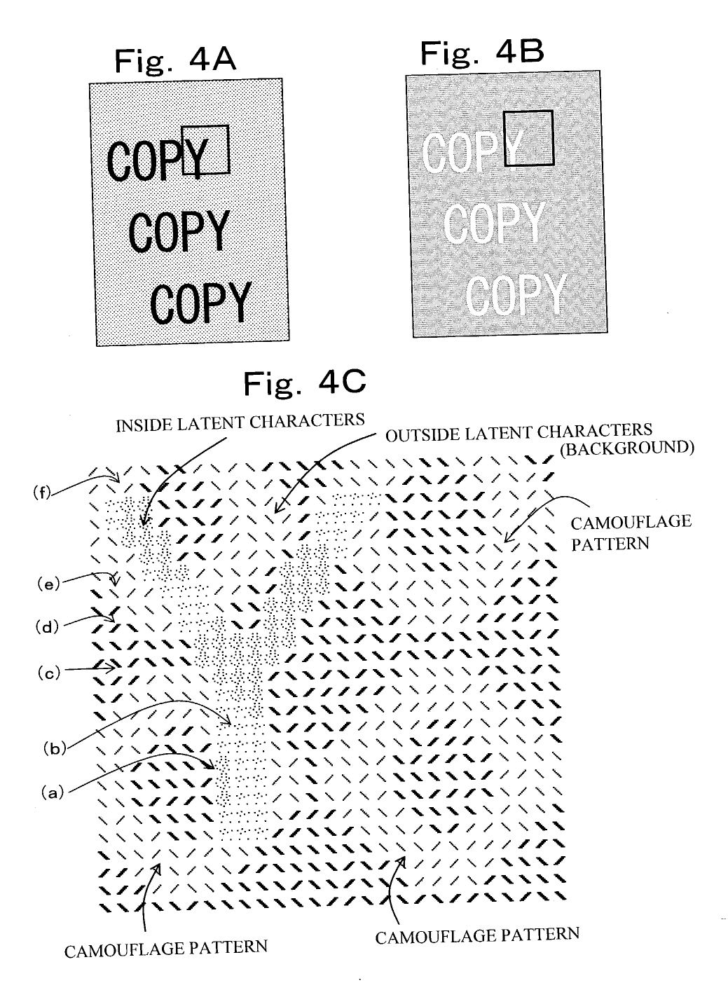

Referring next to FIG. 4, a copy guard pattern image to be printed out will be described. FIG. 4A illustrates the entire copy guard pattern. The image data of this copy guard pattern are binary monochrome image data containing 1 bit per pixel. The characters “COPY” shown in FIGS. 4A and 4B are latent characters with the same density as the background density, and, in practice, cannot be seen as clearly as in the drawings. However, the characters “COPY” are clearly shown in these drawings, for ease of explanation. An enlarged view of a part of the latent characters (the area indicated by a rectangle) is shown in FIG. 4C.

As can be seen from FIG. 4C, the inside of each latent character includes patterns in which relatively small dots are randomly and densely arranged. The patterns shown in FIGS. 5E and 5F correspond to these inside patterns. The outside of the latent characters (the background area) is formed by relatively large diagonal patterns that are relatively sparsely arranged. Also, the background area includes diagonal patterns of different thicknesses. The latent character area is formed by the pattern cells of a predetermined size with different dot densities.

Also, as can be seen from FIG. 4C, the background pattern includes camouflage patterns. These camouflage patterns are arranged on the entire area of the copy guard pattern. In this copy guard pattern, the patterns inside the latent characters are different from the patterns outside the latent characters. However, after the copy guard pattern is printed out onto a paper sheet, the average density (the ratio of the black pixel area to each unit area) in the area inside each of the latent characters is the same as the average density in the area outside the latent characters.

On the other hand, there is a density difference between the inside and the outside of each camouflage pattern. Accordingly, the latent characters are invisible to the human eye, but it appears as if only the camouflage patterns are arranged on the entire area of the paper sheet. When the original document having this image printed out thereon is duplicated by a copying machine, the relatively large dots outside the latent characters are accurately reproduced.

However, the relatively small dots inside each of the latent characters cannot be adequately reproduced by a copying machine. As a result, only the outside (the background area) of the latent characters are reproduced in the duplicated output, while the areas of the latent characters turn out to be blank as shown in FIG. 4B. What is to be actually printed out onto the paper sheet is an image having the original document image combined with the pattern image shown in FIG. 4A.

Here, the original document image is a completely blank document image including no characters and drawings, for ease of explanation. Also, the background area of the copy guard pattern is made up of two types of diagonal patterns representing two-dimensional codes of bits “0” and “1”. Accordingly, digital information is embedded as the two-dimensional codes in the copy guard pattern.

Next, the operation of the image processing system of this embodiment will be described. The operation of printing out document data from the client apparatus 1 is as follows. First, a user issues an instruction to print out a document from the client apparatus 1. At this point, the user determines, on the menu screen displayed by the printer driver, whether to add a copy guard pattern to the background area of the document to be printed out. If a copy guard pattern is to be added, the user sets a character string to be embedded as latent characters, the color of the copy guard pattern, and the number of the camouflage pattern to be combined with the copy guard pattern.

Based on the setting values set by the user, the printer driver retrieves the setting information of the copy guard pattern. The printer driver then converts the document data (the application data) into PDL data, and adds the setting information of the copy guard pattern to the header of the PDL data. The printer driver further adds the IP address of the client apparatus 1 and the name of the user who has logged in, as the additional information, to the header.

The PDL data are then transmitted to the multi-function apparatus 2 via the network 3. In the multi-function apparatus 2, the PDL data are first received by the network interface 4, and are then temporarily stored in the memory (not shown) provided in the controller 5. The controller 5 checks the PDL data stored in the memory to determine whether the setting information of the copy guard pattern is included in the PDL data. If the setting information of the copy guard pattern is included in the PDL data, the operation mode of the image processing apparatus is set to a copy guard pattern combining mode. The latent character string information, the color information, the camouflage pattern number, and the additional information are then retrieved from the setting information of the copy guard pattern, and are set into the copy guard pattern generator 10 of the image processor 7.

If the setting information of the copy guard pattern is not included in the PDL data, the operation mode of the multi-function apparatus 2 is set to a regular operation mode. In the regular operation mode, the copy guard pattern generating process and the copy guard pattern combining process described later are not carried out.

The image processor 7 reads out the PDL data from the memory in the controller 5, and inputs the PDL data to the document image generator 15. The document image generator 15 analyzes the PDL data to generate a document image. The document image generator 15 then outputs and stores the document image into the page buffer 16. Along with this operation, the copy guard pattern generator 10 generates a copy guard pattern image. In the following, the operation of the copy guard pattern generator 10 will be described in greater detail, with reference to FIG. 3.

FIG. 3 illustrates the operation of the copy guard pattern generator 10. As shown in FIG. 3, a latent character string, a camouflage pattern number, and additional information are input from the controller 5 to the copy guard pattern generator 10. Here, the additional information contains the IP address of the client apparatus 1 and the name of the user who has logged in.

The encoder 21 performs error correction encoding on the additional information input from the controller 5, and thereby generates a bit string in the form of a two-dimensional arrangement code of 15×15 bits shown in FIG. 8. The latent character string input from the controller 5 forms a binary latent image in the latent image memory (not shown) in the latent image generator 22. The generated latent image is output to the pattern selector 26.

Also, the camouflage pattern selector 24 selects the camouflage pattern corresponding to the camouflage pattern number input from the controller 5, from the camouflage patterns stored in the camouflage pattern storage unit 23. The selected camouflage pattern is repeatedly placed on the entire image area with a resolution of 50 dpi, and is then output to the pattern selector 26.

The pattern selector 26 selects one of the six patterns stored in the pattern storage unit 25, based on the value of each bit in the code input from the encoder 21, the pixel value of each pixel in the camouflage pattern image input from the camouflage pattern selector 24, and the pixel value of each pixel in the latent image input from the latent image generator 22. The pattern selector 26 then outputs the selected pattern as image data. In the following, the pattern selecting process carried out by the pattern selector 26 will be described in detail, with reference to FIGS. 4A through 4C, FIGS. 5A through 5F, and FIG. 7.

Receiving the value of each bit in the two-dimensional arrangement code, the pixel value of each pixel in the camouflage pattern image, and the pixel value of each pixel in the latent image, the pattern selector 26 selects a pattern from the pattern storage unit 25, based on the value of each input factor. The pattern selector 26 then reads the selected pattern. In a case where the latent image is formed with black pixels while the camouflage pattern is formed with white pixels, the pattern selector 26 selects the pattern shown in FIG. 5E, which has the higher dot density in the predetermined pattern cell (corresponding to (a) in FIG. 4C).

In a case where the latent image is formed with black pixels while the camouflage pattern is also formed with black pixels, the pattern selector 26 selects the dot pattern shown in FIG. 5F, which has the lower dot density in the predetermined pattern cell (corresponding to (b) in FIG. 4C). In a case where the latent image is formed with white pixels while the camouflage pattern is also formed with white pixels, with the bit value of the code being “0”, the pattern selector 26 selects the bold diagonal pattern shown in FIG. 5A, which is tilted to the left (corresponding to (c) in FIG. 4C).

In a case where the latent image is formed with white pixels while the camouflage pattern is also formed with white pixels, with the bit value of the code being “1”, the pattern selector 26 selects the bold diagonal pattern shown in FIG. 5B, which is tilted to the right (corresponding to (d) in FIG. 4C).

In a case where the latent image is formed with white pixels while the camouflage pattern is formed with black pixels, with the bit value of the code being “0”, the pattern selector 26 selects the diagonal pattern shown in FIG. 5C, which is tilted to the left (corresponding to (e) in FIG. 4C). In a case where the latent image is formed with white pixels while the camouflage pattern is formed with black pixels, with the bit value of the code being “1”, the pattern selector 26 selects the diagonal pattern shown in FIG. 5D, which is tilted to the right (corresponding to (f) in FIG. 4C).

As a result, image data in which each one pixel in the overlapping image of the latent image and the camouflage image is represented by a pattern image of 12×12 pixels are output. As the size of each one pattern is 12×12 pixels, the resolution of the image output from the pattern selector 26 is 12 times higher than 50 dpi, i.e., 600 dpi. As shown in FIG. 4C, this output image has dot patterns in the latent characters area, and repetitive two-dimensional codes formed with the diagonal patterns of different inclinations representing the bits values in the entire background area. The output image further includes a pattern in which a camouflage pattern repeatedly appears, as the diagonal patterns have different thicknesses and the pattern cells have different dot densities. The pattern image including the camouflage patterns formed by the variations of the thicknesses of the patterns corresponding to the two-dimensional codes and the numbers of dots forming the latent characters is stored in the page buffer 11.

Referring back to FIG. 2, the explanation of the printing operation of the multi-function apparatus 2 is resumed. After the generation of a document image and a copy guard pattern image, image outputting is preformed. The color components of the document image data stored in the page buffer 16 are sequentially read out: black, cyan, magenta, and yellow, in that order. The screen processor 12 converts the document image data into a binary image through screen processing. The pattern combiner 13 then generates the copy guard pattern, and outputs the copy guard pattern to the image forming unit 8.

The image forming unit 8 performs an image forming operation for each color component, and carries out a printing process to print out a full-color image. Thus, a document image combined with the copy guard pattern is printed out. Here, the pattern combiner 13 carries out a combining process for the screened binary document image data and the binary copy guard pattern image through an OR operation, only when a predetermined color component among black, cyan, and magenta is output.

When any of the other color components is output, the pattern combiner 13 does not carry out any processing, and simply outputs the input image as it is. Although the IP address of the client apparatus 1 and the name of the user who has logged in are contained in the additional information to be included in the two-dimensional code to be embedded in the background of a copy guard pattern in this embodiment, any digital information may be included as long as the size of the information stays within the information capacity of the two-dimensional code.

The two patterns shown in FIGS. 5E and 5F to be arranged in the latent character area have different numbers of dots per pattern cell in this embodiment. However, it is also possible to employ pattern cells that contain the same numbers of dots, if the sizes of the dots are varied. For instance, instead of the pattern shown in FIG. 5E, a pattern having long dots each containing 3×1 pixels at the same locations as the dots in the pattern shown in FIG. 5F can be employed. A camouflage pattern with the same density variation as the variation between the patterns shown in FIGS. 5E and 5F can be formed with the above pattern having long dots each containing 3×1 pixels and the pattern shown in FIG. 5F, as the number of pixels in the pattern cell of the pattern shown in FIG. 5E is three times greater than the number of pixels in the pattern cell of the pattern shown in FIG. 5F. Also, the dots each having a dot size of 3×1 pixels are not accurately reproduced by a copying machine, and result in blanks that stands out on a paper sheet. Thus, the latent characters can be visually recognized.

Also, in this embodiment, the pattern image data are formed with the six patterns consisting of the four diagonal patterns and the two dot patterns representing machine-readable codes. However, the types of patterns are not limited to the six types, as long as particular information is represented by machine-readable codes.

The process of generating a copy guard pattern image may be carried out by either hardware or software.

As described above, according to the present invention, a camouflage pattern is formed by varying the thicknesses of the two-dimensional patterns arranged in the background and the numbers of dots in the dot patterns arranged in the latent image area. In this manner, a camouflage pattern can be repeatedly formed both in the background and the latent image areas, without a decrease of precision in detecting the patterns forming two-dimensional codes. Thus, an image processing apparatus that can achieve both an excellent precision in detecting each two-dimensional code and a high image quality (the ability to hide latent characters) in a copy guard pattern can be realized.

(Second Embodiment)

The following is a description of a second embodiment of the present invention. In the first embodiment, a copy guard pattern is formed when an image received from the client apparatus 1 is printed out. In this embodiment, a copy guard pattern is formed when an original document is read by the image reader 6 shown in FIG. 2 and is duplicated. The system structure of this embodiment is the same as the system structure of the first embodiment, and therefore explanation of the components of the structure is omitted herein. However, the operation of the system structure of this embodiment differs from the operation of the system structure of the first embodiment.

In the following, an operation at a time of duplication will be described. Through the control panel 9 of the multi-function apparatus 2, a user can select not only a regular copying mode but also an operation mode in which a copy guard pattern is to be added. First, the user operates the control panel 9 to set the operation mode of the multi-function apparatus 2 to a copy guard pattern adding mode. By doing so, a screen for inputting a user ID and a password, a screen for setting a latent character string, a screen for setting the color of the copy guard pattern, and a screen for setting a camouflage pattern, are displayed on the control panel 9. The user performs all the setting through those screens.

After the setting by the user, the operation enters the copy guard pattern adding mode. The latent character string and the camouflage pattern number selected through the control panel 9 are set into the copy guard pattern generator 10 by the controller 5. Also, the ID number of the user, the machine ID number of the multi-function apparatus 2, and the date information are set as additional information into the copy guard pattern generator 10. Further, the composite color for the copy guard pattern is set into the pattern combiner 13.

The copy guard pattern generator 10 generates a copy guard pattern image in the same manner as in the copy guard pattern generating operation in the first embodiment. The generated copy guard pattern image is stored in the page buffer 11. When the generation of the copy guard pattern is complete, the preparation for a duplicating operation is complete. The user then places an original document on the platen of the image reader 6, and presses the copy start button to start a duplicating operation. After the image reader 6 reads the original document, the color converter 14 converts the read image into image data of the CMYK color space, and then stores the converted image data in the page buffer 16.

The color components of the document image data stored in the page buffer 16 are sequentially read out: black, cyan, magenta, and yellow, in that order. The screen processor 12 converts the image data into a binary image through screen processing. The pattern combiner 13 then generates the copy guard pattern, and outputs the copy guard pattern to the image forming unit 8. The image forming unit 8 performs an image forming operation for each color component, and carries out a printing process to print out a full-color image. Here, the pattern combiner 13 carries out a combining process for the screened binary document image data and the binary copy guard pattern image through an OR operation, only when a predetermined color component among black, cyan, and magenta is output. When any of the other color components is output, the pattern combiner 13 does not carry out any processing, and simply outputs the input image as it is.

In this embodiment, each camouflage pattern is formed by varying the thicknesses of the two-dimensional patterns arranged in the background area and the numbers of dots in the dot patterns arranged in the latent image area. Accordingly, a camouflage pattern can be repeatedly formed both in the background and the latent image areas, without a decrease of precision in detecting the patterns forming the two-dimensional codes. Thus, an image processing apparatus that can achieve both an excellent precision in detecting each two-dimensional code and a high image quality (the ability to hide latent characters) in a copy guard pattern can be realized.

(Third Embodiment)

In the first and second embodiments, the generation of each copy guard pattern is performed in the image processor contained in the multi-function apparatus 2. In this embodiment, however, the generating and combining of each copy guard pattern image are performed by the printer driver of the client apparatus 1, and the image generating operation is set in a computer program.

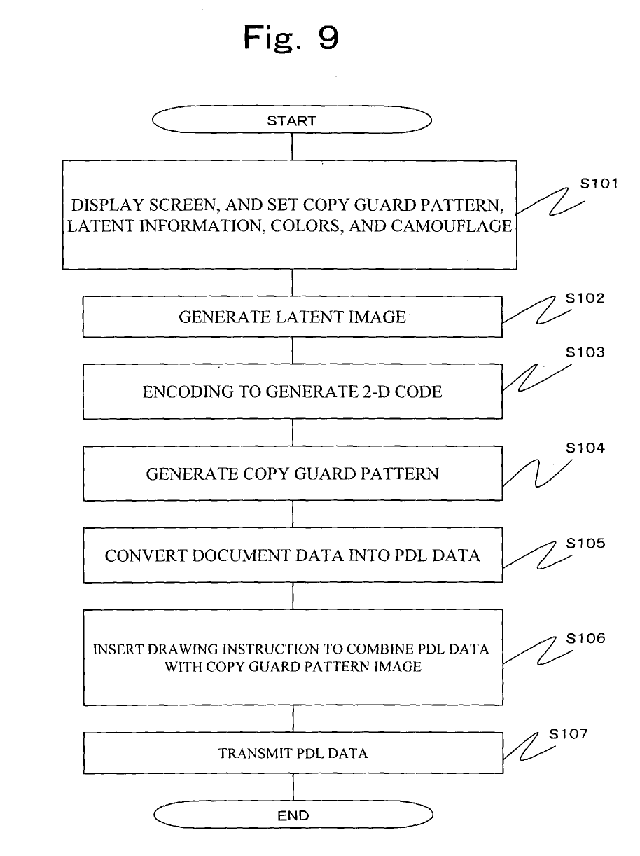

Referring to FIG. 9, the pattern image generating operation at a time of printing out a document will now be described. First, a user issues an instruction to print out a document from the client apparatus 1. By doing so, a printer driver screen is displayed, and the user sets additional information to be embedded in the document to be printed out (S101). At this point, the user determines whether a copy guard pattern is to be added to the background of the document to be printed out. If a copy guard pattern is to be added to the document, the user also sets a character string to be embedded as latent characters, colors for the copy guard pattern, and a camouflage pattern. After the setting by the user, the printer driver generates a latent image (S102).

The printer driver then retrieves additional information including the IP address of the client apparatus 1 and the name of the user who has logged in. The printer driver then performs encoding on the additional information to generate a two-dimensional code (S103). Based on the encoded data, the selected camouflage pattern, and the latent image, the printer driver generates a copy guard pattern image (S104).

In a case where a copy guard pattern image that is a background pattern image is to be generated, a copy guard pattern generating operation is performed in the same manner as the copy guard pattern generating operation described in the description of the first embodiment with reference to FIG. 3. The camouflage pattern used here is the camouflage pattern selected by the user in step S101 from camouflage patterns stored beforehand in the driver. After the above operation, the document data to be printed out are converted into PDL data (S105).

Next, a drawing instruction to form the copy guard pattern image generated in step S014 as a background image is added to the PDL data generated in step S105 (S106). Finally, the PDL data are transmitted to the multi-function apparatus 2 (S107). The multi-function apparatus 2 analyzes the PDL data in a regular manner, and combines the copy guard pattern image with the document image in accordance with the drawing instruction. Thus, a composite image is printed out.

In this embodiment, the generating and combining of each copy guard pattern image are performed by the printer driver of the client apparatus 1. Accordingly, a camouflage pattern can be formed by varying the thicknesses of the patterns that form the two-dimensional codes in the same manner as in the first embodiment, without a decrease of precision in detecting the patterns forming the two-dimensional coded.

In this embodiment, document data are converted into PDL data, and a drawing instruction to combine a copy guard pattern image with the document data is added to the PDL data. The PDL data are then transmitted to the printer, and the actual image combining process is carried out within the printer. However, it is also possible to convert document data into image data within the printer driver, and combine the image data with a pattern image The composite image data can be transmitted directly to the printer, which then prints out the composite image.

Also, in this embodiment, the document data produced by an application program are transmitted as PDL data to the multi-function apparatus 2, which then prints out the document. However, when image data read by a scanner connected to the client apparatus 1 are to be printed out, a pattern image may also be generated and combined with the image data within the driver in the same manner as in this embodiment. The composite image data can be transmitted to the printer to print out the composite image.

Each operation performed by the driver of the client apparatus 1 is performed in accordance with the image generating program. This image generating program operates together with the hardware, and accordingly, performs each image generating operation together with the hardware. Although not shown in the drawings, the hardware includes a CPU, internal memory devices such as a ROM and a RAM, external memory devices such as a FDD, a HDD, and a CD-ROM drive, input devices such as a keyboard and a mouse, an output device such as a printer, and a computer equipped with a display device.

The image generating method is stored as an image generating program in a memory medium such as a FD, a HD, or a CD-ROM, which is connected to a corresponding external memory device. When an image generating operation is performed, the image generating program is read out and loaded into a RAM. The memory medium in which the image generating program is stored may also be a semiconductor memory such as a ROM.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image processing apparatus that generates a background pattern to be combined with document data, comprising
a pattern generator that generates a background pattern including a first region in which patterns that correspond to a predetermined code and are to be reproduced at a time of duplication are arranged, a second region in which patterns that are not to be reproduced at a time of duplication are arranged, and camouflage patterns formed by variations of the patterns to be reproduced at a time of duplication and the patterns not to be reproduced at a time of duplication.

2. The image processing apparatus as claimed in claim 1, wherein the pattern generator forms the camouflage patterns by varying the thicknesses of the patterns arranged in the first region and the numbers of dots in the patterns arranged in the second region.

3. The image processing apparatus as claimed in claim 1, wherein the pattern generator includes a pattern storage unit that stores predetermined different types of patterns, and a selector that selects a pattern from the predetermined different types of patterns for each pixel in accordance with data that describes each of the patterns to be reproduced at a time of duplication, data that describes each of the patterns not to be reproduced at a time of duplication, and data that describes each of the camouflage patterns.

4. The image processing apparatus as claimed in claim 1, wherein the pattern generator includes a camouflage pattern storage unit that stores different types of camouflage patterns, and the pattern generator selects a camouflage pattern from the different types of camouflage patterns in accordance with an instruction from the outside, and thereby generates the background pattern.

5. The image processing apparatus as claimed in claim 1, wherein the pattern generator includes a data generator that generates data describing each of the patterns to be reproduced at a time of duplication in accordance with additional information supplied from the outside, and another data generator that generates data describing each of the patterns not to be reproduced at a time of duplication in accordance with a character string supplied from the outside.

6. The image processing apparatus as claimed in claim 1, further comprising a pattern combiner that combines the background pattern with an input image supplied from the outside.

7. The image processing apparatus as claimed in claim 1, further comprising:
a reader that optically reads an original document; and
a pattern combiner that combines the background pattern with an input image output from the reader.

8. The image processing apparatus as claimed in claim 1, further comprising a determiner that determines whether the background pattern is to be combined with an input image.

9. The image processing apparatus as claimed in claim 1, wherein the predetermined code is a two-dimensional code.

10. An image processing method in which a background pattern to be combined with document data is generated, the method comprising the step of
generating a background pattern that includes a first region in which patterns that correspond to a predetermined code and are to be reproduced at a time of duplication are arranged, a second region in which patterns that are not to be reproduced at a time of duplication are arranged, and camouflage patterns formed by variations of the patterns to be reproduced at a time of duplication and the patterns not to be reproduced at a time of duplication.

11. The image processing method as claimed in claim 10, wherein the step of generating a background pattern includes the step of generating the camouflage patterns by varying the thicknesses of the patterns arranged in the first region and the numbers of dots in the patterns arranged in the second region.

12. The image processing method as claimed in claim 10, wherein the step of generating a background pattern comprises the steps of storing predetermined different types of patterns, and selecting a pattern from the predetermined different types of patterns for each pixel in accordance with data that describes each of the patterns to be reproduced at a time of duplication, data that describes each of the patterns not to be reproduced at a time of duplication, and data that describes each of the camouflage patterns.

13. The image processing method as claimed in claim 10, wherein the step of generating a background pattern comprises the steps of storing different types of camouflage patterns, and selecting a camouflage pattern from the different types of camouflage patterns in accordance with an instruction from the outside, and thereby generates the background pattern.

14. The image processing method as claimed in claim 10, wherein the step of generating a background pattern comprises the steps of generating data describing each of the patterns to be reproduced at a time of duplication in accordance with additional information supplied from the outside, and generating data describing each of the patterns not to be reproduced at a time of duplication in accordance with a character string supplied from the outside.

15. The image processing method as claimed in claim 10, further comprising the step of combining the background pattern with an input image supplied from the outside.

16. The image processing method as claimed in claim 10, further comprising the steps of:
optically reading an original document; and
combining the background pattern with an input image obtained by optical reading.

17. The image processing method as claimed in claim 10, further comprising the step of determining whether the background pattern is to be combined with an input image.

18. The image processing method as claimed in claim 10, wherein the predetermined code is a two-dimensional code.

19. An image processing program product for generating a background pattern to be combined with document data, the program product comprising a function to operate a computer as a pattern generator that generates a background pattern including a first region in which patterns that correspond to a predetermined code and are to be reproduced at a time of duplication are arranged, a second region in which patterns that are not to be reproduced at a time of duplication are arranged, and camouflage patterns formed by variations of the patterns to be reproduced at a time of duplication and the patterns not to be reproduced at a time of duplication.

20. The image processing program product as claimed in claim 19, wherein the pattern generator generates the camouflage patterns by varying the thicknesses of the patterns arranged in the first region and the numbers of dots in the patterns arranged in the second region.
